(19) United States
(12) Patent Application Publication
(10) Pub. No.: US 2012/0008063 A1
(43) Pub. Date: Jan. 12, 2012

(54) LIQUID CRYSTAL DISPLAY DEVICE

(75) Inventor: Tomohiro Asamizu, Osaka (JP)

(73) Assignee: SHARP KABUSHIKI KAISHA, Osaka (JP)

(21) Appl. No.: 13/256,616

(22) PCT Filed: Feb. 4, 2010
(86) PCT No.: PCT/JP2010/051593

§ 371 Date: Sep. 14, 2011

(30) Foreign Application Priority Data
Mar. 23, 2009 (JP) 2009-070803

(51) Int. Cl. G02F 1/1335

(52) U.S. Cl. 349/61

(57) ABSTRACT

An object of the present invention is to provide a liquid crystal display device capable of uniformly irradiating the entire liquid crystal panel with light (that is, capable of preventing light irradiation non-uniformity that can be recognized by viewers), without excessively increasing the number of point light sources (LEDs). In the liquid crystal display device of the present invention, in a backlight substrate region where a plurality of point light sources (L1 to L8) are disposed in a grid arrangement pattern, a position which is within a virtual rectangular region surrounded by four adjacent point light sources, and which is furthest from each of the adjacent point light sources is defined as an anisotropy reference position (G1 to G3). Light emitted from the point light source closest to the anisotropy reference position is selectively diffused in a direction toward the reference position (G1 to G3) by the anisotropic optical member (82), thereby realizing the optical anisotropy is that direction.

### TECHNICAL FIELD

The present invention relates to a liquid crystal display device having a plurality of point light sources as a light source. The present application claims priority to Patent Application No. 2009-070803 filed in Japan on Mar. 23, 2009, and the entire contents of which are hereby incorporated by reference.

### BACKGROUND ART

Liquid crystal display devices having a liquid crystal panel capable of providing high-definition color images with low power consumption are used for various applications (such as home televisions, mobile phones, and personal computers, for example) as display devices displaying videos and images. Because a liquid crystal element constituting a liquid crystal panel is a non-self light emitting element, in order to improve the luminance of a panel, a backlight device including light sources in various forms is installed in a liquid crystal display device.

As one example of such a back light device, a backlight device provided with a plurality of point light sources such as high brightness white LEDs (Light Emitting Diode) is known.

As the size of liquid crystal panels is becoming increasingly larger in recent years, the number of the point light sources installed in the backlight device using the point light sources tends to increase to prevent the light irradiation non-uniformity from the light source, such as a part of the liquid crystal panel not being irradiated or receiving less amount of light irradiated thereto compared to other parts. From the perspective of saving electric power or reducing manufacturing cost, however, it is preferable to be able to uniformly irradiate the entire liquid crystal panel with light (that is, to prevent the light irradiation non-uniformity (luminance non-uniformity)) without increasing the number of the light sources.

Disclosed in Patent Document 1 is a backlight device designed to expand a light irradiation region by forming a recess to guide outgoing light from each point light source into the inside of a light guide plate in order to irradiate a larger region with one point light source. Such a design disclosed in Patent Document 1 is, however, for expanding the light irradiation region from an individual point light source, and it is still difficult to uniformly irradiate the entire surface of a liquid crystal panel by such a design.

### RELATED ART DOCUMENTS

### Patent Documents

Patent Document 1: Japanese Patent Application Laid-Open Publication No. 2007-005111

### SUMMARY OF THE INVENTION

### Problems to be Solved by the Invention

The present invention was made in view of the above points and it is a main object of the present invention to provide a liquid crystal display device capable of irradiating the entire liquid crystal panel uniformly with light (that is, preventing the light irradiation non-uniformity that can be recognized by viewers) without excessively increasing the number of point light sources, even when a relatively large liquid crystal panel is to be provided.

### Means for Solving the Problems

To achieve the above-mentioned object, a liquid crystal display device provided by the present invention including: a liquid crystal display panel; a plurality of optical members placed on a back surface side of the liquid crystal panel; and a backlight device placed on the back surface side of the optical members, wherein the backlight device includes a backlight substrate having a plurality of point light sources, wherein the plurality of point light sources are disposed on the backlight substrate in a prescribed point light source arrangement pattern such that the point light sources are interspersed, being spaced with each other, in a region facing the liquid crystal panel, wherein the optical members include an anisotropic optical member having optical anisotropy that diffuses light emitted from each of the point light sources in prescribed directions, and wherein, in a region of the backlight substrate in which the plurality of point light sources are arranged in the prescribed point light source arrangement pattern, when a position that is within a region surrounded by any three or four adjacent point light sources, and that is the furthest position when viewed from each of the adjacent point light sources is defined as an anisotropy reference position, the optical anisotropy is such that light emitted from the point light source closest to the anisotropy reference position is selectively diffused toward the reference position.

The liquid crystal display device according to the present invention is characterized in that the anisotropic optical member having the optical anisotropy, which is the anisotropic optical member having the optical anisotropy with which light emitted from the point light source closest from the anisotropy reference positions is selectively (preferentially) diffused in the directions toward the reference positions is provided therein.

In this manner, in the liquid crystal display device according to the present invention, the sufficient amount of light can reach even the furthest positions from the point light sources, such as the anisotropy reference position from one of the point light sources. Therefore, by the liquid crystal display device according to the present invention, the entire liquid crystal panel can be irradiated with light almost uniformly without excessively (unnecessarily) increasing the number of the point light sources and the generation of the excessive light irradiation non-uniformity that is recognizable by viewers can be prevented.

A preferable aspect of the liquid crystal display device disclosed here is characterized in that the point light source arrangement pattern is a pattern in which the plurality of point light sources are arranged in a grid pattern in the region of the backlight substrate, wherein, in a virtual quadrangular region surrounded by four adjacent point light sources as the vertices in the grid point light source arrangement pattern, the anisotropy reference position is defined as the furthest position when viewed from the respective four point light sources.

According to the present invention, a liquid crystal display device having a plurality of point light sources arranged in such a grid arrangement pattern and capable of almost uniformly irradiating the entire liquid crystal panel with light is provided.

Another preferable aspect of the liquid crystal display device disclosed here is characterized in that the point light source arrangement pattern is a pattern in which a plurality of point light sources are arranged in a staggered pattern in a prescribed direction in the region of the backlight substrate, wherein, in a virtual triangular region surrounded by three adjacent point light sources as the vertices in the staggered point light source arrangement pattern, the anisotropy reference position is defined as the furthest position when viewed from the respective three point light sources.

According to the present invention, a liquid crystal display device having a plurality of point light sources arranged in such a staggered arrangement pattern and capable of almost uniformly irradiating the entire liquid crystal panel with light is provided.

Another preferable aspect of the liquid crystal display device disclosed herein is characterized in that the liquid crystal display device includes an anisotropic diffusion member formed in a shape of a plate or a sheet as the anisotropic optical member.

By having such a configuration, the object of the present invention can be achieved with ease.

Another preferable aspect of the liquid crystal display device disclosed herein is characterized in that the liquid crystal display device includes a lens member formed in a shape of a plate or a sheet as the anisotropic optical member.

By having such a configuration, the object of the present invention can be achieved with ease.

Also, another preferable aspect of the liquid crystal display device disclosed herein is characterized in that the anisotropic optical member of the plurality of optical members is placed at a position closest to the point light sources.

In a liquid crystal display device of such a configuration, by placing the anisotropic optical member of the plurality of optical member at the closest position to the point light sources, the generation of non-uniformity in light irradiation can be prevented more reliably.

### BRIEF DESCRIPTION OF THE DRAWINGS

FIG. 1 is an exploded perspective view schematically showing a configuration of a liquid crystal display device according to an embodiment of the present invention.

FIG. 2 is a cross-sectional view schematically showing a configuration of a liquid crystal display device according to an embodiment of the present invention.

FIG. 3 a cross-sectional view of a main section schematically showing point light sources and optical members provided in a liquid crystal display device according to an embodiment of the present invention.

FIG. 4A is a drawing schematically explaining diffusion directions of light emitted from each point light source of a liquid crystal display device according to an embodiment of the present invention.

FIG. 4B is a drawing schematically explaining the emission range of light emitted from each point light source of a liquid crystal display device according to an embodiment of the present invention.

FIG. 5A is a drawing schematically explaining diffusion directions of light emitted from each point light source of a liquid crystal display device according to an embodiment of the present invention.

FIG. 5B is a drawing schematically explaining the emission range of light emitted from each point light source of a liquid crystal display device according to an embodiment of the present invention.

FIG. 6A is a drawing schematically explaining diffusion directions of light emitted from each point light source of a liquid crystal display device according to an embodiment of the present invention.

FIG. 6B is a drawing schematically explaining the emission range of light emitted from each point light source of a liquid crystal display device according to an embodiment of the present invention.

FIG. 7A is a drawing schematically explaining diffusion directions of light emitted from each point light source of a liquid crystal display device according to an embodiment of the present invention.

FIG. 7B is a drawing schematically explaining the emission range of light emitted from each point light source of a liquid crystal display device according to an embodiment of the present invention.

FIG. 8A is a drawing schematically explaining diffusion directions of light emitted from each point light source of a liquid crystal display device according to an embodiment of the present invention.

FIG. 8B is a drawing schematically explaining the emission range of light emitted from each point light source of a liquid crystal display device according to an embodiment of the present invention.

FIG. 9 is a cross-sectional view of a main section schematically showing point light sources and optical members provided in a liquid crystal display device according to an embodiment of the present invention.

FIG. 10 is a cross-sectional view of a main section schematically showing point light sources and optical members provided in a liquid crystal display device according to an embodiment of the present invention.

FIG. 11A is a front view of a main section schematically showing a placement of each point light source of a conventional liquid crystal display device.

FIG. 11B is a drawing schematically explaining the emission range of light emitted from each point light source of a conventional liquid crystal display device.

### DETAILED DESCRIPTION OF EMBODIMENTS

Hereinafter, several preferred embodiments of the present invention are described with reference to the figures. The items which are not the matters specifically mentioned in this specification (optical members, for example), and are necessary to implement the present invention (such as a structure and a configuration method of a liquid crystal panel, and electric circuits related to a driving method of light sources installed in a liquid crystal display device, for example) can be understood as design matters of those skilled in the art based on the prior art in the field. The present invention can be implemented based on the contents disclosed in this specification and the technical common knowledge in the field.

First, an active matrix type (TFT type) liquid crystal display device 100 including a liquid crystal panel 10 according to a preferred embodiment of the present invention is explained. In the figures hereinafter, the same reference characters are given to members and parts that have the same functions, and overlapping explanations may be omitted or simplified. Also, dimensional relations (length, width, thickness and the like) in each figure do not necessarily reflect actual dimensional relations precisely. Additionally, in the explanations below, “front side” or “surface side” is referring to a side facing viewers in the liquid crystal display device 100 (which is a liquid crystal panel side), and “reverse side” or “back surface side” is referring to a side not facing viewers in the liquid crystal display device 100 (which is a side to a backlight device 70 placed behind the liquid crystal panel).

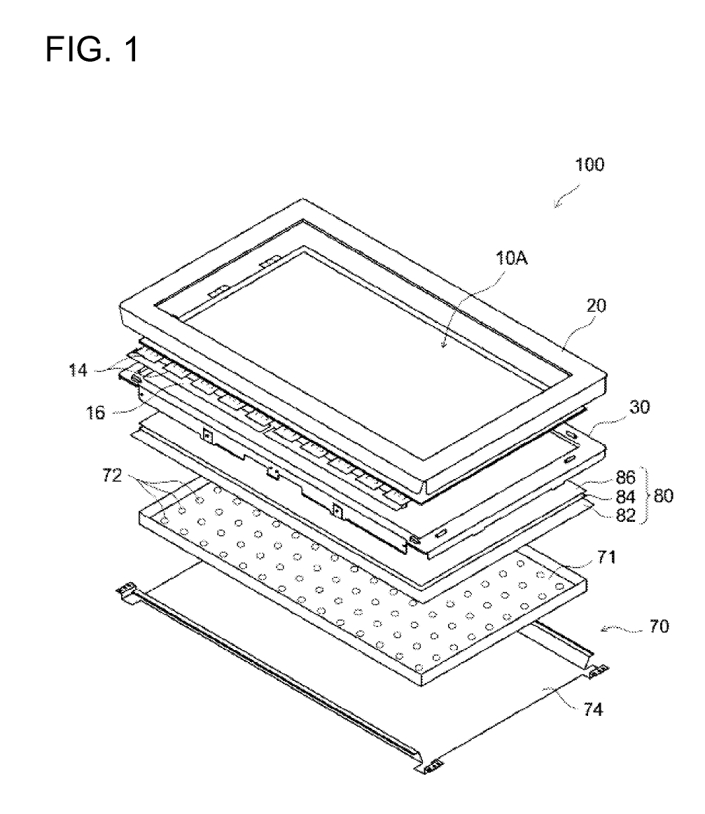

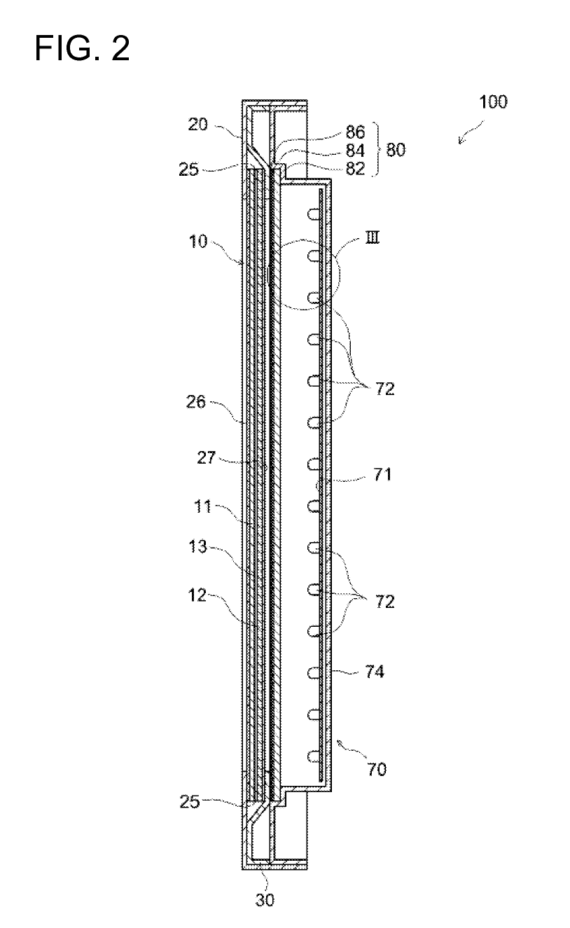

Referring to FIGS. 1 and 2, a schematic configuration of the liquid crystal display device 100 is explained. As shown in FIG. 1, the liquid crystal display device 100 includes a liquid crystal panel 10 and a backlight device 70, which is an external light source, placed in the reverse side (the bottom side in FIG. 1) of the liquid crystal panel 10. These are integrally held by being coupled with a bezel 20 and the like.

The liquid crystal panel 10 generally has a rectangular shape as a whole, and has a display region 10A that has pixels formed therein to display images in the center region thereof. Also, this liquid crystal panel 10 has a sandwich structure constituted by a pair of transparent glass substrates 11 and 12 facing each other, and a liquid crystal layer 13 filled therebetween. For the substrates 11 and 12, substrates that are cut out from large base members, called a mother glass in the manufacturing process, are respectively used. Of the pair of substrates 11 and 12, the one on the front side is a color filter substrate (CF substrate) 11 and the other on the reverse side is an array substrate 12. In margin areas of the substrates 11 and 12 (the margin area in the liquid crystal panel 10), a sealing material 25 is provided so as to enclose the display region 10A to seal the liquid crystal layer 13. The liquid crystal layer 13 is constituted of a liquid crystal material including liquid crystal molecules. The orientation of the liquid crystal molecules of the liquid crystal material is manipulated according to the application of an electric field between the substrates 11 and 12, causing the optical characteristics to change. In the liquid crystal layer 13, spacers (not shown) are typically placed at a plurality of locations to ensure the thickness (gap) of such a layer 13. Also, alignment films (not shown) that determine an alignment direction of the liquid crystal molecules are respectively formed on the surfaces of the sides facing each other of both the substrates 11 and 12 (inside). Polarizing plates 26 and 27 are bonded on the respective surfaces of the sides not facing each other (outside).

In the liquid crystal panel 10 disclosed here, on the front side of the array substrate 12 (the side facing the liquid crystal layer 13), pixels (sub pixels, in detail) for displaying images are arranged and a plurality of source wiring lines and a plurality of gate wiring lines for driving each pixel (sub pixel), which are not shown, are formed so as to create a grid pattern. In each grid region surrounded by the wiring lines, a (sub) pixel electrode and a thin film transistor (TFT) that is a switching element are disposed. The pixel electrodes are typically made of ITO (Indium Tin Oxide), which is a transparent conductive material, and a voltage according to an image is supplied to these pixel electrodes through the source wiring lines and the thin film transistors at a prescribed timing.

On the other hand, on the CF substrate 11, a color filter in either one of the colors, R (Red), G (Green) or B (Blue) is placed opposite to one pixel electrode of the array substrate 12. Additionally, a black matrix that divides the color filter of respective colors, and a common electrode (transparent electrode) that is formed uniformly on the surfaces of the color filter and the black matrix are disposed.

As shown in FIG. 1, the source wiring lines and the gate wiring lines are typically connected to a circuit substrate 16, which is an external driving circuit (driver IC) disposed around the liquid crystal panel 10, and which is capable of supplying image signal and the like through a flexible wiring substrate 14.

Here, the configuration of the pixels and the wiring lines of the electrodes described above can be similar to a case where a conventional liquid crystal panel is manufactured, and because the present invention is not characterized thereby, any further detailed explanations will be omitted.

As shown in FIGS. 1 and 2, the backlight device 70 is constituted by a backlight substrate 71 and a case (chassis) 74 that contains the substrate 71. The backlight device 70 has a plurality of point light sources 72 (typically, LEDs) on the backlight substrate 71 as a light source, and includes a not-shown circuit for turning each of the point light sources 72 on/off, so that a power is supplied from the backlight substrate 71 to each of the point light sources (LEDs) 72. As shown in the figures, the plurality of point light sources (LEDs) 72 are arranged in a prescribed arrangement pattern (typically, a grid pattern or a staggered pattern) in a region of the backlight substrate 71 facing the liquid crystal panel 10. In this embodiment, as shown in the figures, as a point light source arrangement pattern, a grid arrangement pattern in which the point light sources 72 are arranged orderly with a prescribed interval is adopted.

As shown in FIGS. 1 and 2, the backlight device 70 is installed on the back surface side of the liquid crystal panel 10 so as to sandwich a frame 30 that is in an almost frame shape and having an opening in a part corresponding to the display region 10A of the liquid crystal panel 10 with the liquid crystal panel 10. Also, in the opening of the frame 30, a plurality of sheet-shaped optical members 80 are laminated and arranged so as to cover the opening. In the configuration (combination) of these optical members 80, an anisotropic optical member 82 corresponding to the anisotropic optical member according to this embodiment, a lens sheet 84, and a brightness enhancement sheet (brightness enhancement film) 86 are arranged in this order from the backlight device 70 side, for example. However, the configuration is not limited to such combination and order.

The liquid crystal display device 100 including the liquid crystal panel 10, the backlight device 70 and the like of the configuration described above controls the liquid crystal molecules in the liquid crystal layer 13 by applying a controlled voltage to the array substrate 12 and the CF substrate 11, so that the light from the backlight device 70 passes through or is blocked in the liquid crystal panel 10. Also, the liquid crystal display device 100 displays a desired image in the display region 10A of the liquid crystal panel 10, while controlling the brightness and the like of the backlight device 70.

Here, such drives and control of the liquid crystal panel 10 can be similar to those of the conventional art. Because the present invention is not characterized thereby, the detailed explanations will be omitted.

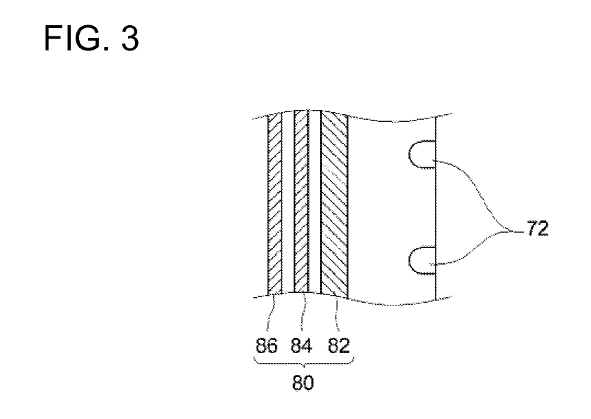

Next, configurations, features, and effects of the point light sources 72 and the optical members 80 of the liquid crystal display device 100 according to this embodiment are explained in detail, referring to FIG. 3. FIG. 3 is a cross-sectional view of a main section schematically showing the positional relations of the backlight substrate 71, the point light sources 72, and the optical members 80 included in the liquid crystal display device 100 according to this embodiment.

As the point light sources 72 of the backlight device 70 of the liquid crystal display device 100 according to this embodiment, various types of point light sources can be used, but typically, point LEDs (white LEDs, for example) are used. LEDs can be used as preferable point light sources because it is easier to control the light emitting time, and the electrode life is longer (100,000 hours or longer, for example), as compared to CCFL (Cold Cathode Fluorescent Lamp) that was conventionally used as a light source.

As shown in FIG. 3, the optical members 80 are constituted by placing the anisotropic optical member 82, the lens sheet 84, and the brightness enhancement sheet 86 in this order from the point light sources (LEDs) 72 toward the surface side. The anisotropic optical member 82 is a diffusion plate (diffusion sheet) made of a synthetic resin that can appropriately set a scattering angle range of light from the point light sources 72. In this embodiment, because the anisotropic optical member 82 is placed in a position closest the point light sources (LEDs) 72, and because the greater degree of the diffusion (anisotropic diffusion) of emitted light of the point light sources (LEDs) 72 can therefore be achieved, the generation of the light irradiation non-uniformity can be prevented more reliably. Also, by using a non-flexible or flexible plate shaped anisotropic optical member 82 (the typical thickness thereof is approximately 1 to 2 mm, 1.5 mm, for example, although not particularly limited to such), the rigidity can be ensured. The lens sheet (typically, a refractive-type prism sheet) 84 is used for deflecting light from the point light sources (LEDs) 72 toward the surface side.

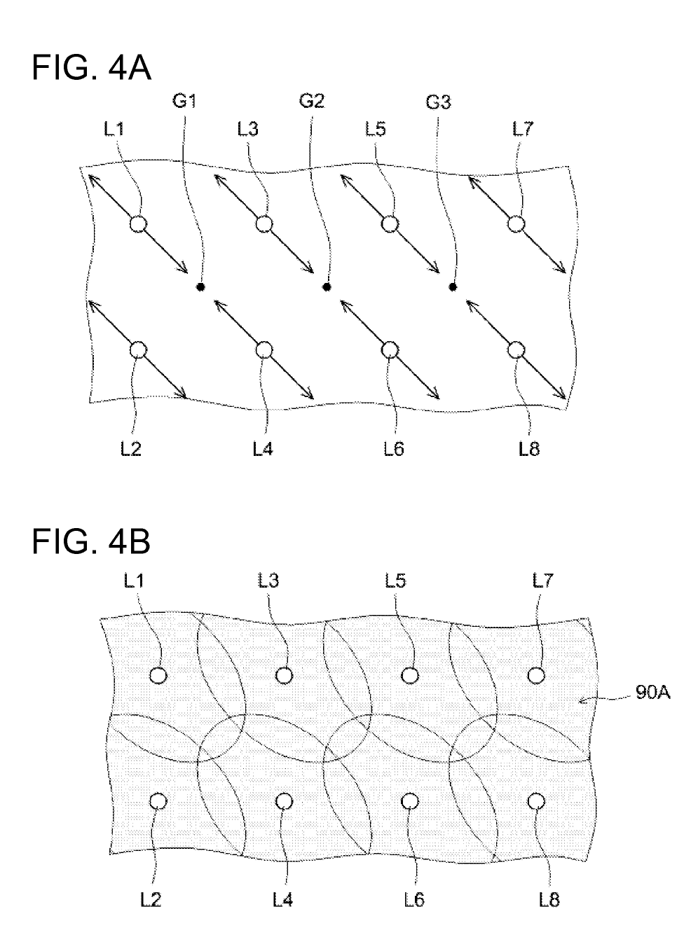

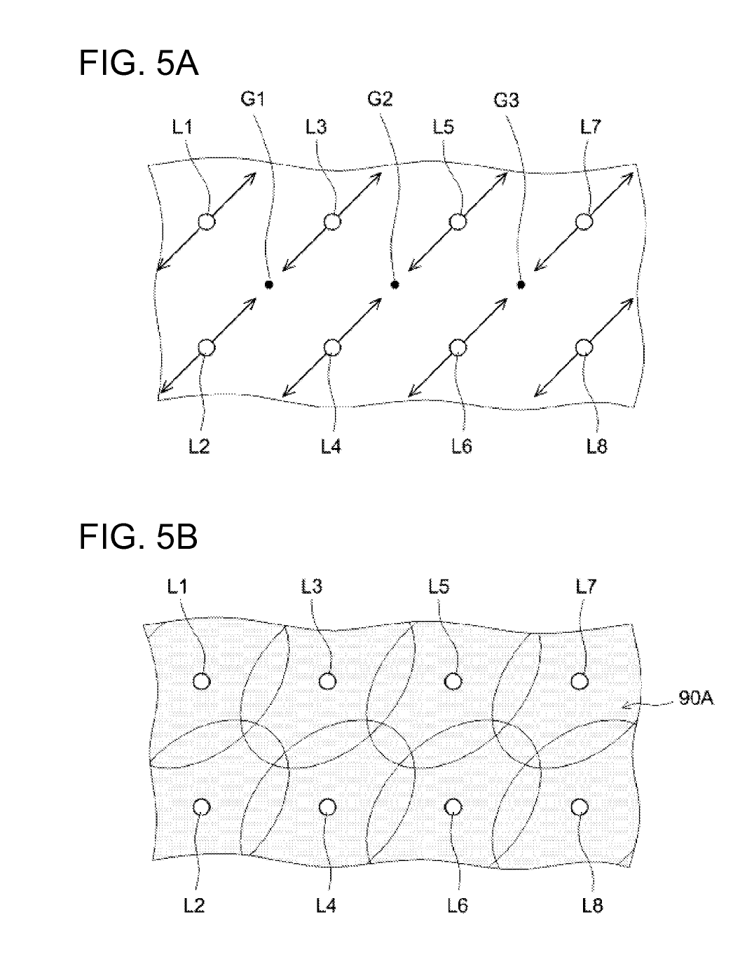

Referring to FIGS. 4A and 4B as well as FIGS. 5A and 5B, cases where the point light sources (LEDs) 72 are arranged in a grid pattern, being spaced with each other, are explained. FIGS. 4A and 5A are the explanatory drawings schematically showing, by the arrows, the main diffusion directions of light emitted from the point light sources (LEDs) 72 of the liquid crystal display device 100 according to this embodiment. FIGS. 4B and 5B are the explanatory drawings schematically showing the light irradiation ranges of the point light sources (LEDs) 72 of the liquid crystal display device 100 according to this embodiment. In these drawings, the point light sources (LEDs) 72 are indicated with the reference characters L1 to L8. Four adjacent point light sources (the four point light sources indicated with the reference characters L1 to L4, for example) constitute the vertices of a virtual rectangle (square) of this embodiment. The reference character G1 in the drawing is defined as the furthest position (anisotropy reference position) from the four point light sources L1 to L4 within the virtual rectangular region surrounded by the four point light sources L1 to L4. In a similar manner, the anisotropy reference positions within the virtual rectangular regions surrounded by other four point light sources L3 to L6, and L5 to L8, are G2 and G3, respectively.

In this embodiment, as described above, the anisotropic optical member 82 is provided as an optical member. The optical anisotropy of the optical member 82 is provided such that emitted light from the one of the point light sources 72 closest to the anisotropy reference position G1 to G3 (one of the light sources indicated with the reference characters L1 to L4 for the anisotropy reference position indicated with G1, for example) is diffused in the direction toward the anisotropy reference position G1 to G3 (the directions of the arrows in FIG. 4A and the directions of the arrows in FIG. 5A) (the manner in which such an optical anisotropy is achieved will be later described).

Specifically, in a case where the point light source arrangement pattern is a grid pattern such as these embodiments (that is, in a case where four adjacent point light sources 72 constitute respective vertices of a virtual square), the optical anisotropy for the entire region of the backlight substrate 71 on which the point light sources 72 facing the liquid crystal panel 10 are placed is set such that light is diffused in the direction toward a point light source 72 constituting a diagonal in the virtual quadrangle when viewed from a respective point light source L1 to L8.

In this manner, the light emission ranges schematically shown in FIGS. 4B and 5B are achieved, and a light irradiation portion 90A in which the non-uniformity in light emission is not generated can be thereby formed in the entire surface of the liquid crystal panel 10.

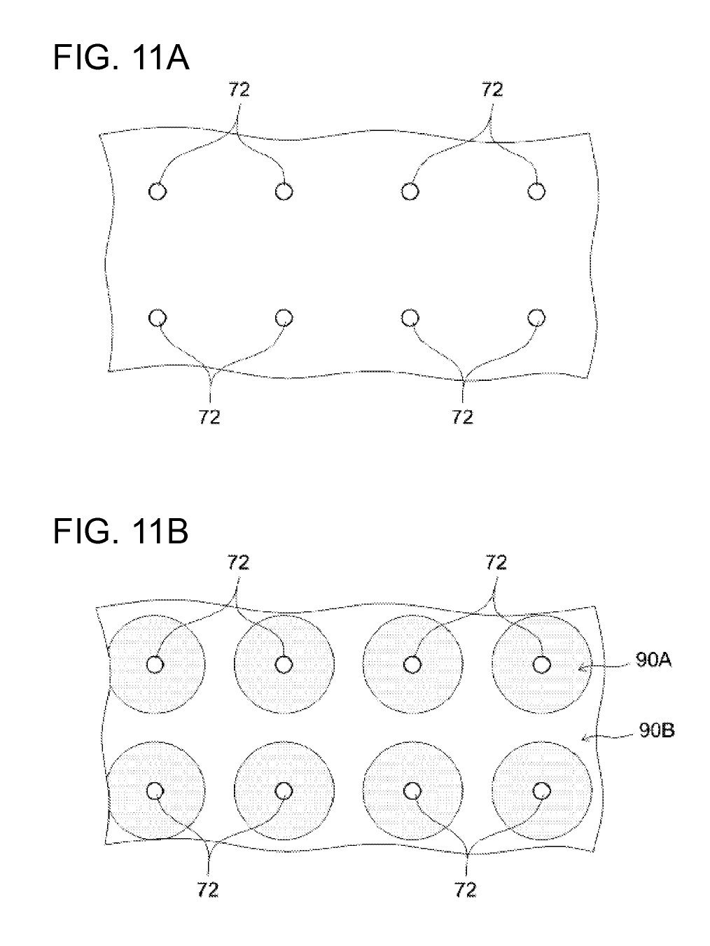

Meanwhile, in a conventional liquid crystal display device in which the point light sources (LEDs) 72 are placed in a grid pattern without having the anisotropic optical member 82 such as this embodiment (see FIG. 11A), because the emitted light of the point light sources 72 is not anisotropically diffused, the emitted light of the point light sources 72 is isotropically diffused as schematically shown in FIG. 11B. Therefore, a portion 90B in which light is not irradiated or light is poorly irradiated may be generated, especially in regions far from the respective point light sources 72 (typically, the anisotropy reference positions).

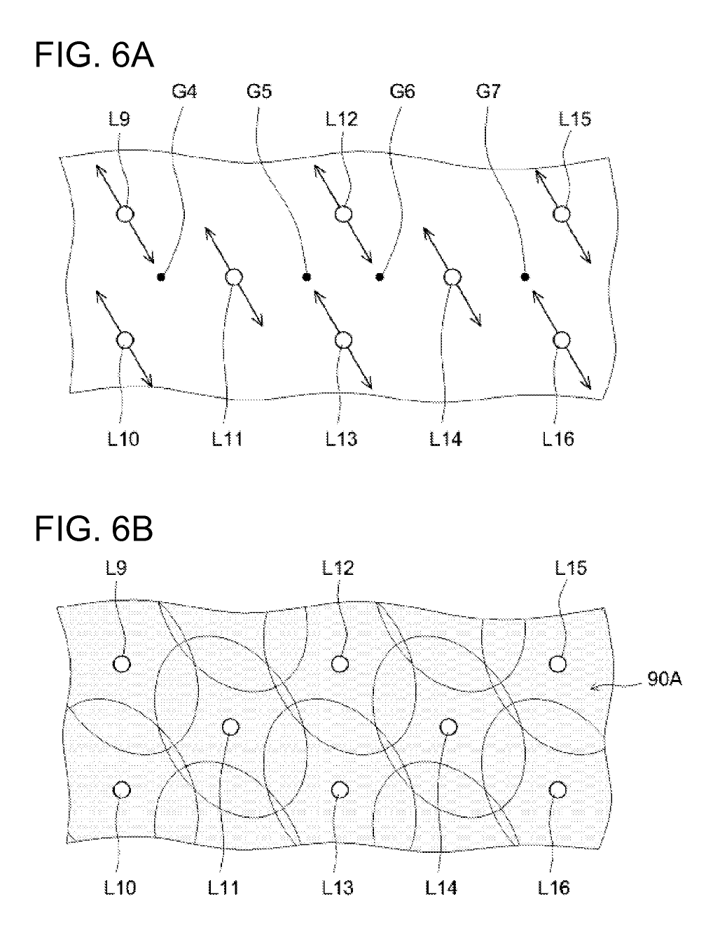

Further, cases where the point light sources (LEDs) 72 are placed in a staggered pattern are explained as another embodiment, referring to FIGS. 6A to 8B. As shown in the figures, in these arrangement patterns as well, the point light sources (LEDs) L9 to L16 are interspersed, being spaced with each other. Three adjacent point light sources (the three point light sources indicated with the reference characters L9 to L11, for example) constitute the vertices of a virtual triangle (equilateral triangle). The reference character G4 in the drawings is the furthest position (anisotropy reference position) from the three point light sources L9 to L11 within the virtual triangular region surrounded by the three point light sources L9 to L11. In a similar manner, the anisotropy reference positions of other three point light sources L11 to L13, L12 to L14, and L14 to L16, are G5 to G7, respectively.

Here, in this embodiment as well, the anisotropic optical member 82 is provided as an optical member. The optical anisotropy of the optical member 82 is formed such that light emitted from the one of the point light sources 72 closest to the anisotropy reference position G4 to G7 (one of the light sources indicated with the reference characters L9 to L11 for the anisotropy reference position indicated by G4, for example) is diffused in the direction toward the anisotropy reference position G4 to G7 (the directions of the arrows in FIGS. 6A, 7A, and 8A).

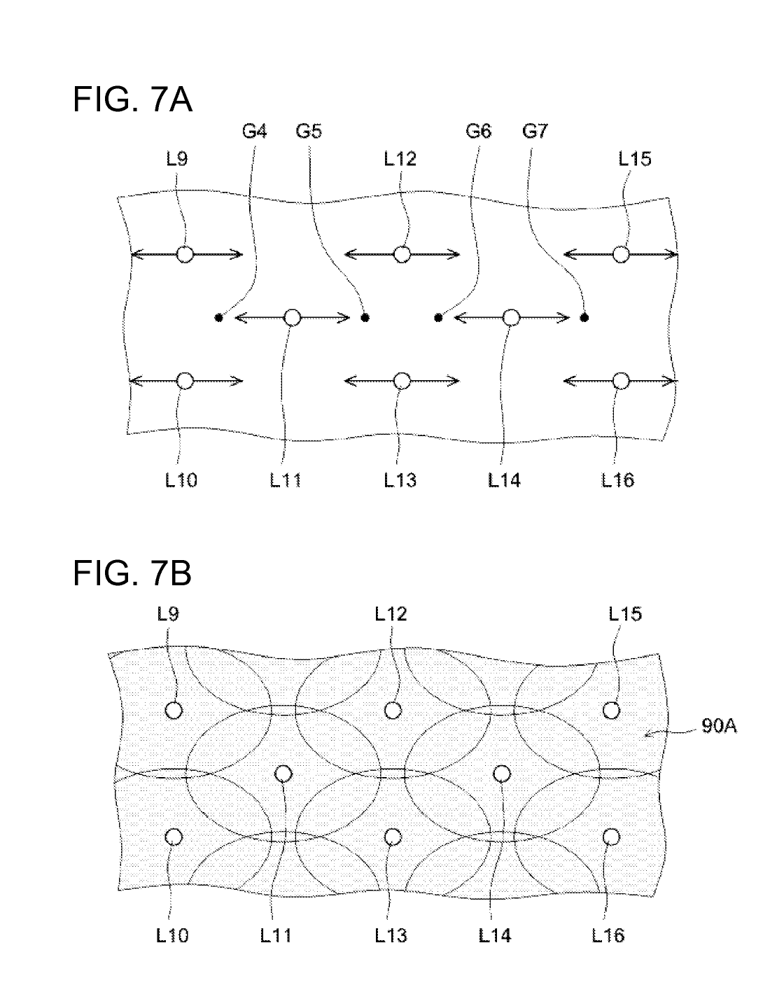

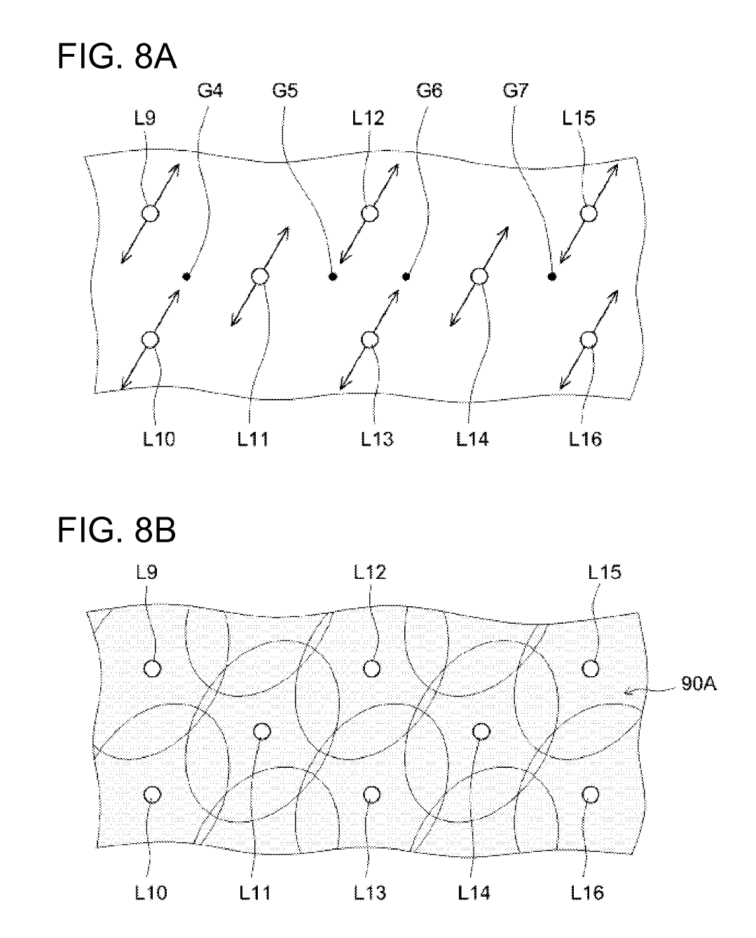

Specifically, in cases where the point light source arrangement pattern is a staggered pattern such as these embodiments (that is, in cases where three adjacent point light sources constitute respective vertices of a virtual equilateral triangle), the anisotropy reference positions G4 to G7 are corresponding to the centers of gravity of the respective virtual equilateral triangles. Therefore, in the cases of this embodiment, the optical anisotropy in the entire region of the backlight substrate 71 on which the point light sources 72 facing the liquid crystal panel 10 are placed is set such that light is diffused in the direction from one of the point light sources constituting one of the virtual triangles (the light source of the reference character L9, L10, or L11, for example) toward the anisotropy reference position within the virtual triangular region (the anisotropy reference position of the reference character G4, for example). That is, the optical anisotropy in the entire region of the backlight substrate 71 on which the point light sources 72 facing the liquid crystal panel 10 are placed is set such that light is diffused in the direction from the light source of the reference character L9 toward the anisotropy reference position G4 in the example shown in FIG. 6A; diffused in the direction from the light source of the reference character L11 toward the anisotropy reference position G4 (center of gravity) in the example shown in FIG. 7A (which becomes the horizontal direction of the liquid crystal panel 10, in this case); and is diffused in the direction from the light source of the reference character L10 toward the anisotropy reference position G4 in the example shown in FIG. 8A. In this manner, the light emitting ranges schematically shown in FIGS. 6B, 7B, and 8B can be achieved and the light irradiation portion 90A in which the light emission non-uniformity is not generated can be thereby formed in the entire surface of the liquid crystal panel 10.

Next, a manufacturing method of the anisotropic optical member 82 having the prescribed optical anisotropy described in the two embodiments above is briefly explained. As shown in FIGS. 4A to 8B described above, in implementing the present invention, the anisotropic optical member 82 needs to be made or used to achieve the optical anisotropy in which light emitted from the closest point light source from the anisotropy reference position is diffused selectively in the direction toward the reference position. Therefore, there is no particular limitation for the types or materials of the optical member.

Preferable examples include an anisotropic diffusion plate with the anisotropy formed in a prescribed direction made of a synthetic resin such as polyethylene terephthalate, polyethylene naphthalate, acrylic resin, polycarbonate, polystyrene, polyolefin, cellulose acetate, or weather resistance vinyl chloride, for example. In addition to the above mentioned synthetic resin, which is a main material that constitutes the anisotropic diffusion plate, plasticizers, stabilizers, antidegradants, dispersants, optic diffusers, inorganic fillers, and the like may be incorporated, for example. Also, there is no particular limitation for a method to confer the optical anisotropy, and various methods can be adopted. A diffusion plate made of a synthetic resin, formed by dispersing short fiber optic diffusers in a resin matrix so as to align fibers longitudinally in a prescribed direction, can be preferably used as the anisotropic diffusion plate 82, for example. In this manner, by substantially aligning the fibers of the short fiber optical diffusers longitudinally in a prescribed direction, the optical member having the anisotropy can be constructed.

Although the present invention has been explained by the preferable embodiments above, such descriptions are not limiting matters, and various modifications are possible.

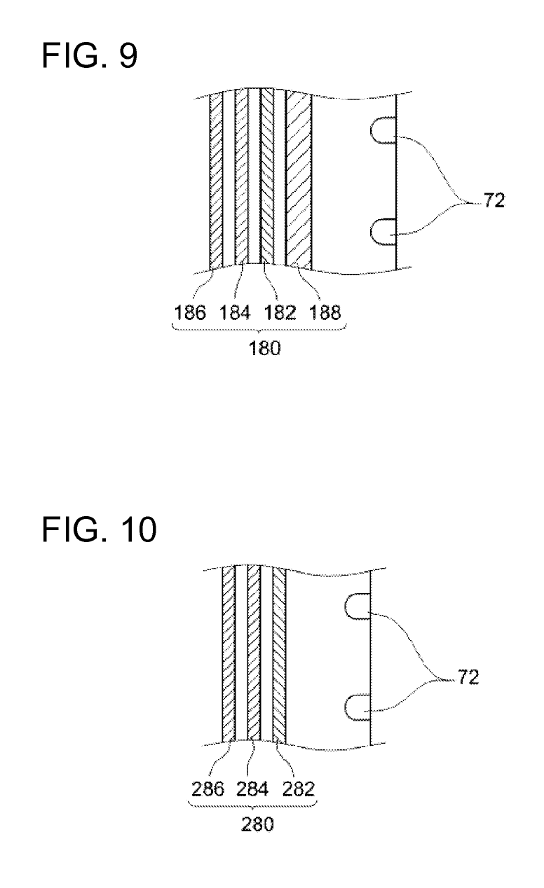

For example, a plurality of optical members 180 may be arranged in the order as shown in FIG. 9 as another embodiment. That is, in this embodiment, the optical members 180 are constituted by placing a diffusion plate 188 not having anisotropy, a sheet-shaped (either flexible or non-flexible) anisotropic optical member 182 (the thickness thereof is approximately 0.2 to 2 mm, typically, 0.5 to 1 mm, for example), a lens sheet (prism sheet, for example) 184, and a brightness enhancement sheet 186 in this order from the backlight device 70 side. In this case, by adopting a thicker diffusion plate (1 mm to 2 mm, for example) as the diffusion plate 188 not having anisotropy, the rigidity of the entire optical members can be further increased.

Also, a plurality of optical members 280 may be arranged in the order as shown in FIG. 10 as another embodiment. That is, in this embodiment, the optical members 280 may be constituted by placing a sheet-shaped anisotropic optical member 282, a lens sheet 284, and a brightness enhancement sheet 286 in this order from the backlight device 70 side. By using such three sheet-shaped members, the entire thickness of the optical members 280 can be reduced, and therefore, a more compact liquid crystal display device can be constructed.

In each embodiment described above, a diffusion plate (diffusion sheet) typically made of a synthetic resin has been adopted as the anisotropic optical member, but the present invention is not limited to such, and the optical anisotropy suitable for the object of the present invention may be provided to a lens member constituting the optical members, for example. As another embodiment, for example, the optical anisotropy suitable for the object of the present invention can be provided to the above-described lens sheet (typically, a prism sheet) 284 shown in FIG. 10.

A conventional method may be adopted for manufacturing such a lens member 284 (a prism sheet, for example) having the optical anisotropy, and there is no need to adopt a special method in implementing the present invention. In the case of the lens member 284 (a prism sheet, for example) made of a synthetic resin, for example, by extruding a resin forming material, using a extruding die with which the transfer of a prescribed fine surface structure pattern is achieved in the extrusion, a lens member (a prism sheet, for example) given the optical anisotropy that is formed by the transferred pattern can be made. Alternatively, the desired optical anisotropy can be provided by coating a surface of a substrate made of a prescribed synthetic resin material (polyethylene terephthalate (PET), for example) with an appropriate photocurable resin (typically, a UV curable resin) in a state in which a prescribed fine surface structure pattern is transferred (conferred), and by curing the coating with the transferred pattern, which is a known method. By using such a lens member 284 having anisotropy, the present invention can be implemented more easily.

### INDUSTRIAL APPLICABILITY

According to the present invention, a liquid crystal display device including an anisotropic optical member that has the optical anisotropy in which light emitted from the closest point light source from the anisotropy reference position is selectively (preferentially) diffused in the directions toward the reference position is provided. In such a liquid crystal display device, even at the furthest positions from the point light sources, the sufficient amount of light can reach from one of the point light sources. As a result, the entire liquid crystal panel can be irradiated with light almost uniformly without excessively increasing the number of point light sources, even when a relatively large liquid crystal panel is to be provided.

### DESCRIPTION OF REFERENCE CHARACTERS

10 liquid crystal panel
10A display region
11 color filter (CF) substrate
12 array substrate
13 liquid crystal layer
14 flexible wiring substrate
16 circuit substrate
20 bezel
25 sealing material
26, 27 polarizing plates
30 frame
70 backlight device
71 backlight substrate
72 point light source
74 case (chassis)
76 reflective member
80, 180, 280 optical members
82, 182, 282 anisotropic optical members
84, 184, 284 lens sheets
86, 186, 286 brightness enhancement sheets
90A light irradiation portion
90B non light irradiation portion
100 liquid crystal display device
188 diffusion plate
L1-L16 point light sources (LEDs)
G1-G7 anisotropy reference positions

1. A liquid crystal display device, comprising:
a liquid crystal display panel;
a plurality of optical members placed on a back surface side of the liquid crystal panel; and
a backlight device placed on the back surface side of the optical members,
wherein the backlight device comprises a backlight substrate having a plurality of point light sources,
wherein the plurality of point light sources are disposed on the backlight substrate in a prescribed point light source arrangement pattern such that the point light sources are interspersed, being spaced with each other, in a region facing the liquid crystal panel,
wherein the optical members include an anisotropic optical member having optical anisotropy that diffuses light emitted from each of the point light sources in prescribed directions, and
wherein, in a region of the backlight substrate in which the plurality of point light sources are arranged in the prescribed point light source arrangement pattern, when a position that is within a region surrounded by any three or four adjacent point light sources, and that is the furthest position when viewed from each of said adjacent point light sources is defined as an anisotropy reference position, said optical anisotropy is such that light emitted from the point light source closest to the anisotropy reference position is selectively diffused toward said reference position.

2. The liquid crystal display device according to claim 1, wherein the point light source arrangement pattern is a pattern in which the plurality of point light sources are arranged in a grid pattern in the region of the backlight substrate, and
wherein, in a virtual quadrangular region surrounded by four adjacent point light sources as the vertices in the grid point light source arrangement pattern, the anisotropy reference position is defined as the furthest position when viewed from said respective four point light sources.

3. The liquid crystal display device according to claim 1, wherein the point light source arrangement pattern is a pattern in which a plurality of point light sources are arranged in a staggered pattern in a prescribed direction in the region of the backlight substrate, and
wherein, in a virtual triangular region surrounded by three adjacent point light sources as the vertices in the staggered point light source arrangement pattern, the anisotropy reference position is defined as the furthest position when viewed from said respective three point light sources.

4. The liquid crystal display device according to claim 1, comprising an anisotropic diffusion member formed in a shape of a plate or a sheet as the anisotropic optical member.

5. The liquid crystal display device according to claim 1, comprising a lens member formed in a shape of a plate or a sheet as the anisotropic optical member.

6. The liquid crystal display device according to claim 1, wherein the anisotropic optical member of the plurality of optical members is placed at a position closest to said point light sources.
